(19) United States
(12) Patent Application Publication
(10) Pub. No.: US 2026/0292496 A1
(43) Pub. Date: Sep. 24, 2026

(54) UE-CONTROLLED RIS AND AUTHORIZATION KEY FOR IN-COVERAGE UE

(71) Applicant: QUALCOMM Incorporated, San Diego, CA (US)

(72) Inventors: Mingxi YIN, Beijing (CN); Min HUANG, Beijing (CN); Hao XU, Beijing (CN)

(21) Appl. No.: 19/475,695

(22) PCT Filed: May 29, 2023
(86) PCT No.: PCT/CN2023/096756

§ 371 Date: Oct. 15, 2025

(51) Int. Cl. H04W 12/069; H04B 7/04; H04W 12/037; H04W 12/08

(52) U.S. Cl. CPC H04W 12/069; H04W 12/037; H04W 12/08; H04B 7/04013

(57) ABSTRACT

A method for wireless communication at a user equipment (UE) and related apparatus are provided. In the method, the UE transmits, to a network entity, an authorization request for controlling a reconfigurable intelligent surface (RIS), and receives, from the network entity, an authorization configuration for controlling the RIS. The UE further transmits, to the RIS, authorization information based on the authorization configuration, and transmits, in response to the authorization information being validated by the RIS, a control signal to the RIS for controlling the RIS. The method improves the efficiency and security of UE controlling RIS, while avoiding control collisions when multiple UEs attempt to control the same RIS.

### TECHNICAL FIELD

The present disclosure relates generally to communication systems and, more particularly, to wireless communication including a reconfigurable intelligent surface (RIS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to transmit, to a network entity, an authorization request for controlling a RIS; receive, from the network entity, an authorization configuration for controlling the RIS; transmit, to the RIS, authorization information based on the authorization configuration; and transmit, in response to the authorization information being validated by the RIS, a control signal to the RIS for controlling the RIS.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive, from a first UE, an authorization request for controlling a RIS; provide, in response to the authorization request, the first authorization information to the first UE; and provide second authorization information to the RIS for the RIS to validate the first authorization information.

In an aspect of the disclosure, a method, a computer-readable medium, and an apparatus are provided for wireless communication at a RIS. The apparatus may include at least one memory and at least one processor coupled to the at least one memory. Based at least in part on information stored in the at least one memory, the at least one processor may be configured to receive, from a network entity, the first authorization information for authorizing a UE to control the RIS; receive, from the UE, a control request; grant or deny the control request based on the first authorization information; and communicate, in response to an approval of the control request, with the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating a blockage to wireless communication between a base station and a UE, in accordance with various aspects of the present disclosure.

FIG. 4B is a diagram illustrating a RIS that intelligently reflects communication between a base station and a UE, in accordance with various aspects of the present disclosure.

FIG. 5 is a diagram illustrating a RIS that intelligently reflects communication between a base station and a UE, in accordance with various aspects of the present disclosure.

FIG. 6 is a diagram illustrating an example of a non-transparent UE controlling a RIS, in accordance with various aspects of the present disclosure.

FIG. 7 is a diagram illustrating an example of an in-coverage UE controlling a RIS, in accordance with various aspects of the present disclosure.

FIG. 8 is a call flow diagram illustrating a method of wireless communication in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a network entity in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a RIS in accordance with various aspects of the present disclosure.

FIG. 14 is a flowchart illustrating methods of wireless communication at a RIS in accordance with various aspects of the present disclosure.

FIG. 15 is a diagram illustrating an example of a hardware implementation for an example apparatus and/or UE, in accordance with various aspects of the present disclosure.

FIG. 16 is a diagram illustrating an example of a hardware implementation for an example network entity, in accordance with various aspects of the present disclosure.

FIG. 17 is a diagram illustrating an example of a hardware implementation for a RIS, in accordance with various aspects of the present disclosure.

### DETAILED DESCRIPTION

A reconfiguration intelligent surface (RIS) may be employed to extend coverage, e.g., beamformed coverage, with lower power consumption. The RIS may be composed of a larger number of uniformly distributed electrically controllable elements. Each RIS element may have a reconfigurable electromagnetic characteristic, e.g., a reflection coefficient. Depending on the combination of configured states of the elements, the RIS may reflect and modify the incident radio waveform in a controlled manner, such as changing a reflected direction, changing a beam width, etc. The RIS may receive control signaling from a base station or UE to instruct the RIS to change the direction, beam width, etc. The UE control of the RIS may be transparent or non-transparent to the network. For non-transparent control of the RIS, the UE may obtain an authorization from the network for controlling the RIS. The various aspects presented herein provide for the utilization of an authorization key as a condition for controlling a RIS by an in-coverage UE, including providing aspects for the UE to obtain the network authorization for the control of a RIS, aspects for the RIS to validate the authorization of the UE, and/or aspects to improve the security of the authorization. For example, a UE may request authorization from a base station for controlling a RIS. The base station may respond by sending an authorization key to both the UE and the RIS. The UE may then send the received authorization key to the RIS for validation and confirmation before sending control signals to the RIS. The RIS may use the authorization key received from the base station to validate an authorization key received from the UE and to confirm that the network has authorized the UE to control the RIS before applying control signaling received from the UE. The authorization key may be a paired digital key or a physical key (such as a radio network temporary identifier (RNTI)). In some aspects, the authorization configuration may include a first digital key, and the RIS may grant a control request according to a validation rule related to the first digital key and a second digital key. In some aspects, the authorization configuration may include a physical key indicative of a transmission resource, and the RIS may grant a control request based on the transmission resource used for transmitting the authorization information or a control signal to the RIS. The key can also be used to encrypt or scramble UE-to-RIS control signals, to further improve the security.

Particular aspects of the subject matter described in this disclosure can be implemented to realize one or more of the following potential advantages. In some examples, by utilizing paired digital keys or physical keys, the described techniques can be used to ensure secure access to the RIS for authorized UEs. In some examples, by enabling a network entity to authorize UEs to control RIS, the described techniques help avoid control collisions when multiple UEs try to control the same RIS.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well-known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer-executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

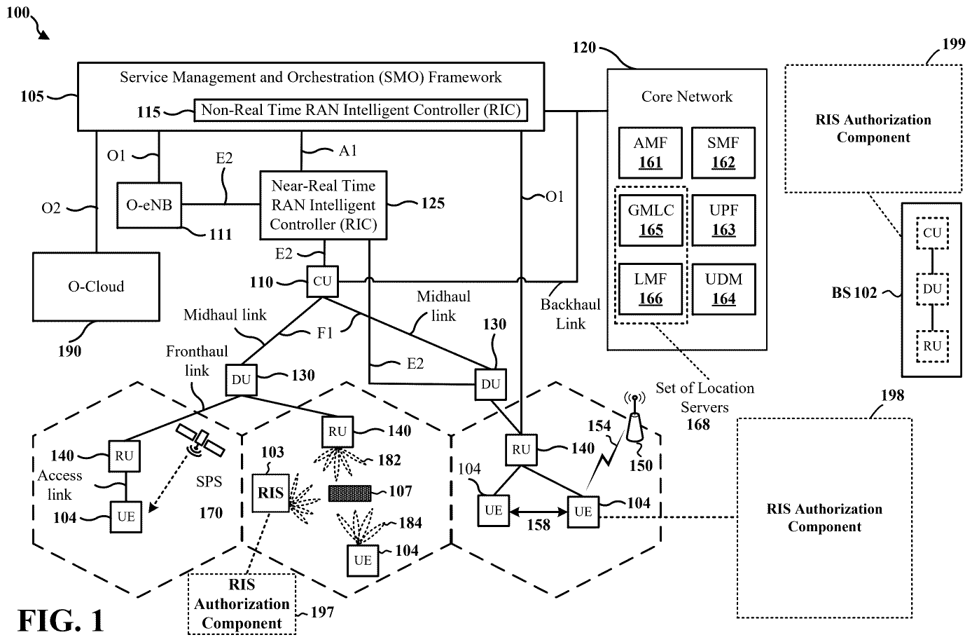

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the wireless communication system may include one or more RIS 103, which may also be referred to by other names. A blockage 107 may occur between a network node transmitting to a UE 104 and the UE 104. The RIS 103 may include a passive antenna array with a surface with a large number of densely placed reconfigurable elements that can reflect or refract an electromagnetic wave in target directions. The RIS 103 may receive communication, e.g., from the RU 140 or the UE 104, an incident angle and reflect or transmit the communication at an angle of reflection, e.g., by controlling reflection coefficients of the antenna elements of the RIS surface, to avoid the blockage 107. The RIS 103 receives and reflects or transmits the communication without decoding the communication.

Referring again to FIG. 1, in certain aspects, the UE 104 may include a RIS authorization component 198. The RIS authorization component 198 may be configured to transmit, to a network entity, an authorization request for controlling a RIS; receive, from the network entity, an authorization configuration for controlling the RIS; transmit, to the RIS, authorization information based on the authorization configuration; and transmit, in response to the authorization information being validated by the RIS, a control signal to the RIS for controlling the RIS. In certain aspects, the base station 102 may include a RIS authorization component 199. The RIS authorization component 199 may be configured to receive, from a first UE, an authorization request for controlling a RIS; provide, in response to the authorization request, the first authorization information to the first UE; and provide second authorization information to the RIS for the RIS to validate the first authorization information. In some aspects, the RIS 103 may include a RIS authorization component 197 configured to receive, from a network entity, the first authorization information for authorizing a UE to control the RIS 103; receive, from the UE, a control request; grant or deny the control request based on the first authorization information; and communicate, in response to an approval of the control request, with the UE. Although the following description may be focused on 5G NR, the concepts described herein may be applicable to other similar areas, such as LTE, LTE-A, CDMA, GSM, and other wireless technologies.

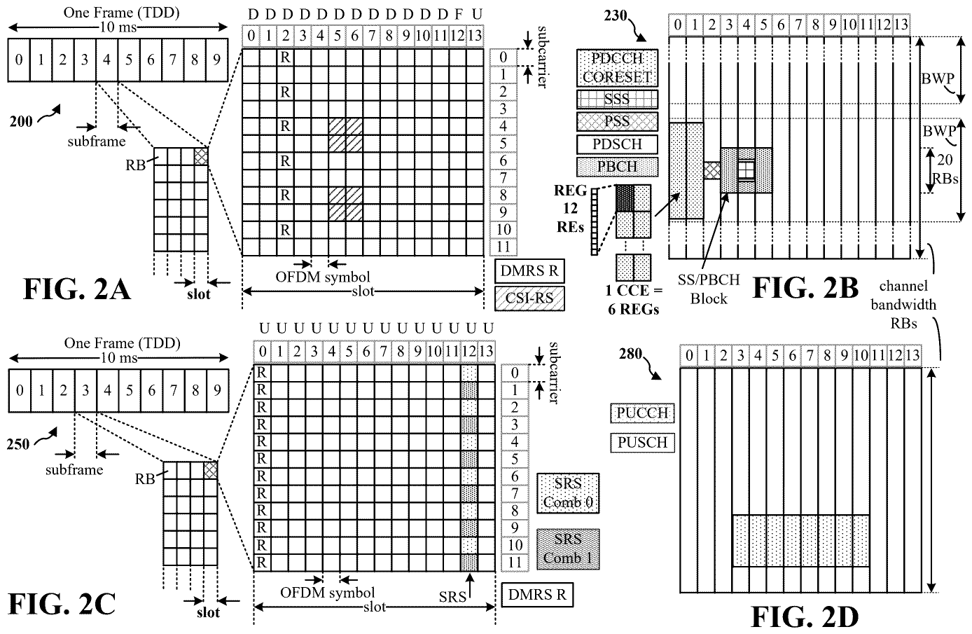

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

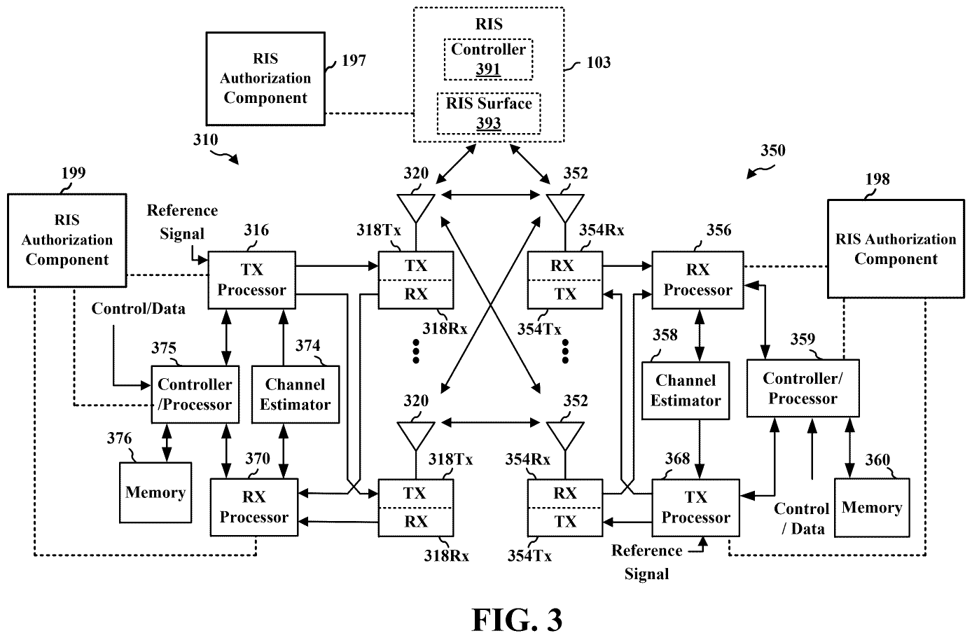

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

FIG. 3 illustrates an example of a RIS 103 that is configured to reflect communication between the base station 310 and the UE 350. The RIS 103 includes a RIS surface 393 of elements that are reconfigurable for different incident angles and reflection angles. The RIS 103 may also include a controller 391 that controls the reflection coefficients of the RIS surface 393 to adjust the angles. In some aspects, the controller 391 may include communication components, e.g., including Tx processor, and Rx processor, and/or a controller processor, such as described for the base station 310 and/or UE 350, in order to receive control signaling regarding the control of the RIS surface 393.

At least one of the TX processor 368, the RX processor 356, and the controller/processor 359 may be configured to perform aspects in connection with a RIS authorization component 198 of FIG. 1.

At least one of the TX processor 316, the RX processor 370, and the controller/processor 375 may be configured to perform aspects in connection with a RIS authorization component 199 of FIG. 1.

In some aspects, the RIS 103 may include a RIS authorization component 197, that is configured to perform the aspects described in connection with FIG. 1.

Beamforming gain may be achieved through the use of active antenna units. Individual RF chains may be used per antenna port. The use of active antenna units (AAU) may increase power consumption. A RIS may be employed to extend coverage, e.g., beamformed coverage, with reduced power consumption. The RIS may include a larger number of uniformly distributed electrically controllable elements. Each RIS element may have a reconfigurable electromagnetic characteristic, e.g., a reflection coefficient. Depending on the combination of configured states of the elements, the RIS may reflect and modify the incident radio waveform in a controlled manner, such as changing a reflected direction, changing a beam width, etc. The RIS may function as a nearly passive device, and the reflection direction may be controlled by the base station. The RIS may reflect an impinging wave in a direction indicated by the base station to a UE.

A RIS may be deployed in wireless communication systems, including cellular communication systems, such as LTE, NR, etc. A RIS may alter the channel realization in a controlled manner, which may improve channel diversity. The increased diversity may provide robustness to channel blocking/fading, which may be of particular importance for mmWave communication. Compared to wireless relay or repeater systems, a RIS may be more cost and energy efficient.

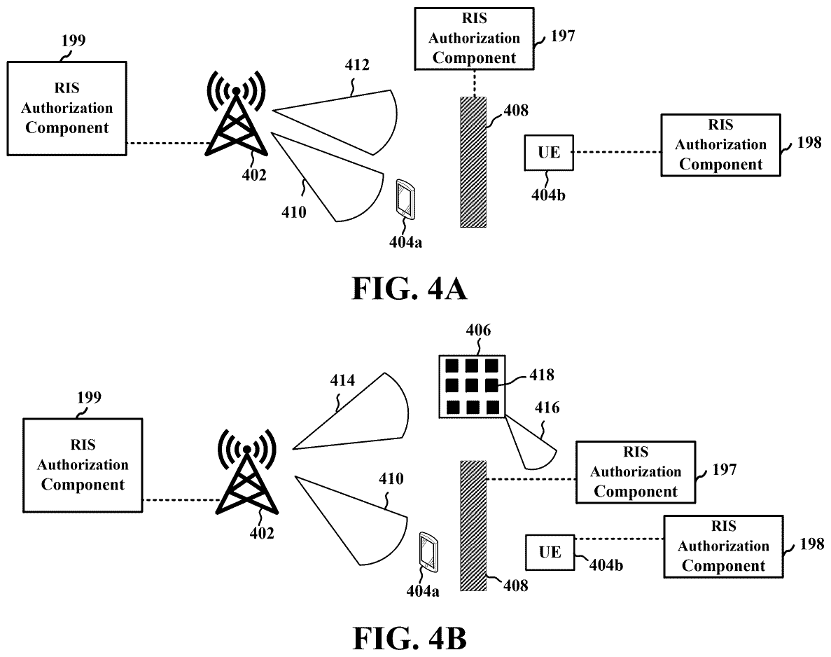

A base station may control the RIS to extend beam coverage and/or to address blockages between the base station and the UE. FIG. 4A illustrates an example in which a base station 402 transmits beamformed communication to UEs using directional beams 410, 412. A first UE 404a may be able to receive direct transmission using the beam 410. However, FIG. 4A illustrates a blockage 408 that blocks beam 412 from reception at the second UE 404b. As illustrated in FIG. 4B, the base station 402 may transmit communication for the second UE 404b using a directional beam 414 (which may be referred to as the impinging beam) to the RIS 406 for reflection over a directional beam 416 to the UE 404b. The base station 402 may indicate the direction of beam 416 to the RIS, and the RIS may reflect the impinging wave on beam 414 in the direction of beam 416. The RIS may include multiple RIS elements 418 that are configured to adjust the reflected direction, the beam width, etc.

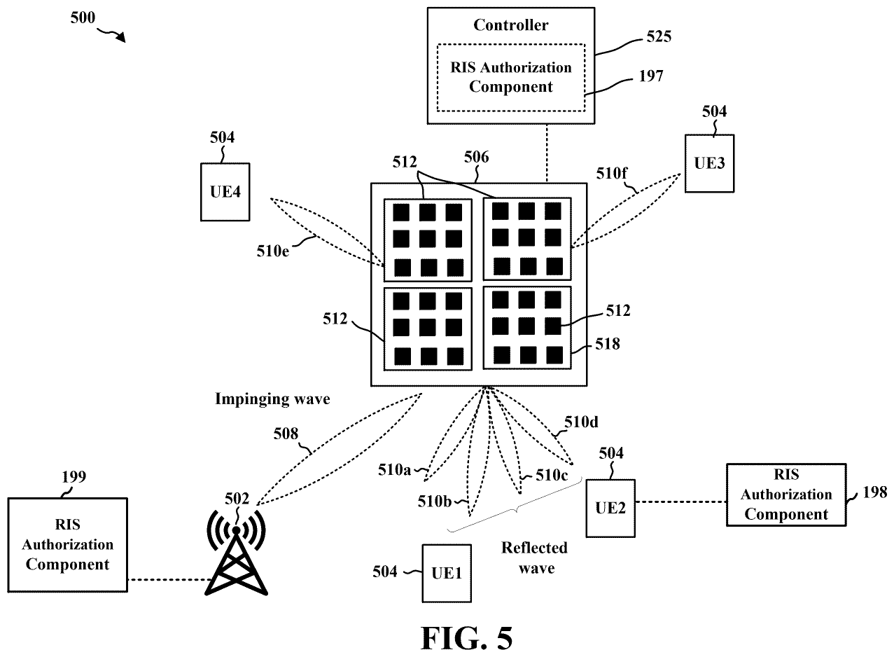

FIG. 5 is a diagram 500 illustrating an example in which the RIS 506 includes multiple subsets 512 of multiple RIS elements 518. As illustrated, different subsets 512 of RIS elements 518 may serve different UEs 504. The RIS elements 518 may be controlled by controller 525 at the RIS 506 based on control information received by base station 502. As described in connection with FIG. 4B, the base station 502 may indicate a beam direction (e.g., any of 510a, 510b, 510c, 510d, 510e, or 510f) to the RIS for reflecting beamformed communication received as the impinging wave 508 to a particular UE 104 in a particular direction. The RIS may similarly be controlled by a UE for reflecting communication from the UE to a base station and/or to another UE.

The RIS may be controlled by a base station 502 and/or a UE 504, which may be referred to as the control node for the RIS. The UE and/or the base station use the RIS for communication, sensing, and/or positioning functions. RIS information may be known by a network based on network planning, and the base station may provide the RIS position and other RIS information to other nodes (e.g., UEs in the cell). For example, the base station may transmit the RIS information in the system information. The UEs in the coverage of the cell may receive the system information in order to discover the presence of a RIS, the RIS position, the RIS capabilities, or other RIS information about a particular RIS. In some aspects, a RIS may be autonomously deployed by an operator or by a third-party user, e.g., and may not be a part of a planned network. In some aspects, the RIS may be mobile RIS.

Example aspects presented herein provide methods and apparatus for controlling and operating RIS in wireless networks. In some aspects, the method involves the use of authorization keys in an in-coverage scenario to enhance the security of a UE-controlled RIS. The present disclosure provides aspects for the UE to obtain the authorization key from the network and for the RIS to verify the authorization of the UE to control the RIS. In some aspects, the base station transmits security keys to the RIS and the UE separately. Subsequently, the UE sends an authorization request to the RIS, incorporating the received key. The RIS then verifies whether the key provided by the UE corresponds to its own key based on a predefined arithmetic relationship. If the keys match, the RIS acknowledges the UE as an authorized device and allows the UE to control the RIS. Alternatively, the method may allocate random resources for the reception of control information from the UE, such that only the UE and RIS with matching keys can accurately receive and process the control commands. This security-enhanced approach helps to ensure that the RIS is only accessible by authorized UEs, thereby preventing unauthorized access and improving overall system security.

A RIS is a surface composed of a large number of densely-placed reconfigurable meta-elements that can reflect or refract electromagnetic (EM) waves to target directions. As a passive antenna array, RISs may perform beamforming in incident and reflection angles. The beams of reflection and incident angle of a RIS may be controlled by reflection coefficients of all antenna elements of the RIS. These coefficients may be set by the RIS controller, which is an active component of the system. The RIS controller may have a simple function of communication and may be further controlled by a network entity, such as a gNB, or a UE in a wireless network.

In various applications, a RIS may not be deployed by network operators but by a third party or user to improve cellular coverage for specific scenarios, such as factories, campuses, office parks, business districts, homes, and vehicles. The RIS may be classified into two types: network-controlled RIS and UE-controlled RIS. UE-controlled RIS may be transparent or non-transparent to the network, allowing UEs to configure and control the RIS via the RIS controller with or without network authorization. As used herein, the term “network” may refer to a base station in a wireless network. As a non-limiting example, in a 5G network, the base station may be a gNB.

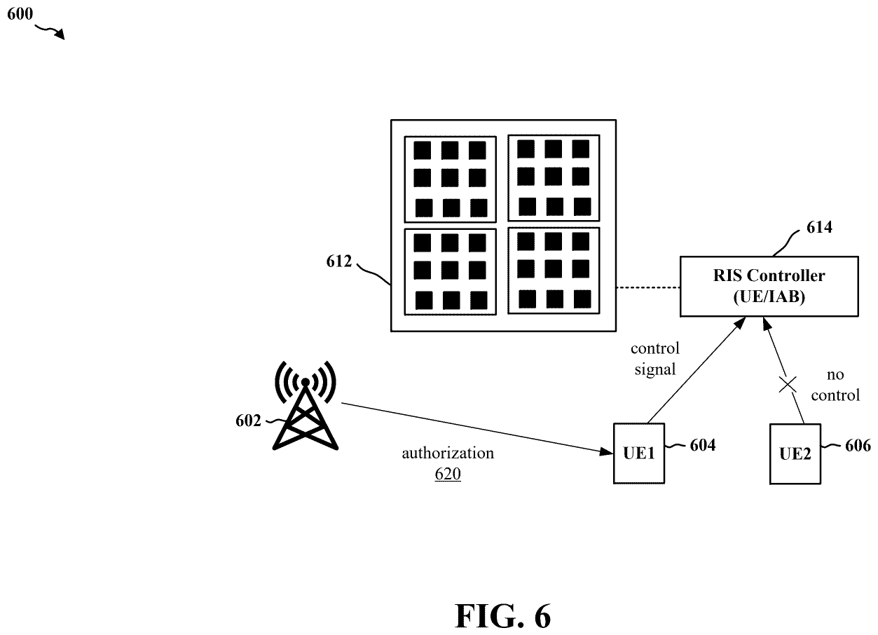

In the example of a UE-controlled RIS that is non-transparent to the network, the UE may first obtain authorization from the network to control the RIS. Once authorized, the UE may control the RIS reflection features, e.g., including the angle or reception and/or reflection, a beam width, etc. To improve the efficiency and avoid collisions when multiple UEs try to control the same RIS, the network may centrally manage and coordinate the control of UE to the RIS. This approach enables the RIS to be utilized as a network service. FIG. 6 is a diagram 600 illustrating an example of a non-transparent UE controlling a RIS. In FIG. 6, the UE 604 may first obtain authorization 620 from a network entity 602 to control a RIS 612. Once authorized, the UE 604 may control the RIS 612 through, for example, a RIS controller 614. For example, the UE may transmit control signaling to the RIS controller with control information for the RIS. In some aspects, the RIS controller 614 may be a component of the RIS. In some examples, the RIS controller 614 may be a UE in the network. In some examples, the RIS controller 614 may be an Integrated Access and Backhaul (IAB) device in the network. FIG. 6 illustrates that the UE 604 is able to send control signaling to the RIS controller 614, and a UE that has not obtained the authorization from the network entity 602, such as UE 606, may not control the RIS 612.

For the network non-transparent (authorizing) UE controlled RIS, certain challenges arise regarding network authorization and security. One primary concern is how a UE can obtain network authorization to control a RIS, and subsequently, how a RIS can validate the authorization of the UE, and how to guarantee the security of the authorization process.

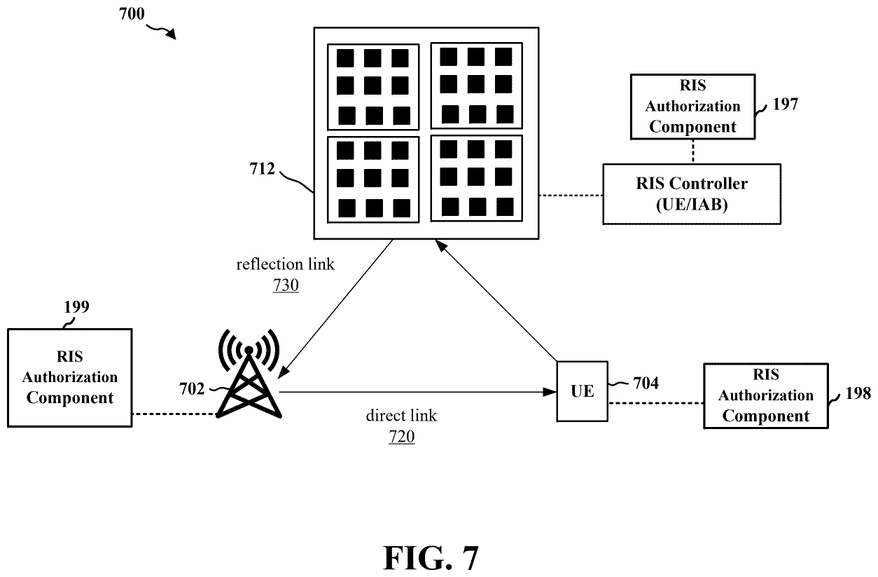

Considering scenarios where the UE is within the coverage of a network, the RIS may be employed to enhance the connection, and both the direct link between the UE and the network and the reflection link by the RIS may exist. In cases where the UE is out of the coverage of a network, a RIS may be utilized to expand the coverage area, and only the reflection link by the RIS is present. FIG. 7 is a diagram 700 illustrating an example of an in-coverage UE controlling a RIS. In FIG. 7, the UE 704 is in the coverage area of the network entity 702. Hence, the direct link 720 between the UE 704 and the network entity 702 and the reflection link 730 between the RIS 712 and the network entity 702 may coexist.

Example aspects presented herein provide solutions for a network authorizing UE to control a RIS and the RIS validating the authorization in a secure manner. As used herein, the term “authorization” may refer to a process of granting a UE the permission to control a RIS (e.g., control the beams of a RIS).

Example aspects presented herein provide a solution for network authorization for an in-coverage UE to control a RIS. In some aspects, for a UE-controlled RIS non-transparent to the network, when the UE is in coverage, the UE may obtain authorization from the network to control a RIS in the cell served by the network. The RIS may be controlled by a UE that has the authorization, e.g., from the network, and may discard control signaling from a UE that does not have the authorization. The network may provide RIS controlling authorization to the UE, and the beam pattern of the RIS may be dedicated to the authorized UE.

When the UE requests authorization to control the RIS from the network, the network may provide both the UE and the RIS an authorization key. The UE may send this authorization key to the RIS for validation and receive confirmation from the RIS before it can send control signals to the RIS.

The authorization key may be implemented in various ways. In some examples, the authorization key may include paired digital keys (e.g., a pair of keys including one key for the UE and one key for the RIS), and each of the paired digital keys may be a data sequence. A pair of digital keys may follow a specific arithmetic rule known by the RIS. In some examples, the authorization key may include a physical key. The transmission resource used by the UE to send the RIS a request or a control may serve as the physical key (similar to a radio network temporary identifier, or RNTI).

Once authorized, the beam (e.g., the reflection coefficients) of the RIS may be controlled by the UE, and the network (e.g., a gNB) may send the RIS control signals to assist in the authorization process. Once the authorization is complete, the control signaling from the authorized UE to the RIS may be scrambled, cyphered, or encoded based on the authorization key provided to the UE and the RIS.

The authorization keys for the authorization process for UE controlled RIS may be implemented in various ways.

In some aspects, the authorization keys may include paired digital keys. The paired digital keys may include data sequences that adhere to specific arithmetic rules. For example, the network may send one of the paired keys to the RIS and the other paired key to the UE. The UE then may send its key to the RIS for validation. The RIS may compare the keys received from the UE and the network. If the keys are paired (e.g., the keys conform to certain arithmetic rules), the RIS determines that UE is authorized. For example, the RIS may use a simple arithmetic rule that the two sequences be equal to determine that the keys match and indicate the UE's authorization to control the RIS. In some aspects, the authorization key may be the UE ID and the network may send the UE ID to the RIS controller, but not to the UE. This option provides greater security against unauthorized UE attacks, but may involve more signaling.

In some aspects, the authorization keys may include physical keys. The time and frequency resource of the UE's RIS request or control may be used as a physical key (similar to an RA-RNTI). For example, the network may provide the grant including the resource for the UE to send RIS control and also indicate this resource to the RIS. Once the RIS detects this resource, the UE that sends on this resource may be authorized. This option allows for less signaling compared to the option with digital keys. The reduction in overhead can improve the efficient use of wireless resources and can save power based on reduced transmission and reception.

In the example aspects presented herein, the UE behavior may be characterized by several actions. Firstly, the UE may receive RIS information through system information blocks (SIB) broadcasted by the network. Additionally, the UE may request unicasted RIS information directly from the network using mechanisms such as UCI, medium access control-control element (MAC-CE), or RRC. The UE may select a RIS based on the received RIS information. The selected RIS may cover the UE based on the UE's position. When there are multiple RIS covering the UE, the UE may evaluate the coverage information of each RIS and identify a RIS with the best coverage by its RIS ID.

Moreover, the UE may request authorization to control a specific RIS from the network using UCI, MAC-CE, or RRC. The request may include one or more RIS IDs. When there are multiple RIS IDs in the request, the front RIS ID may represent a high priority.

Upon receiving an authorization key and the associated RIS ID from the network via DCI, MAC-CE, or RRC, the UE may proceed with the authorization process.

In some aspects, the UE may receive resource allocation from the network, on which the UE may send control signals to a RIS. The type of resources may depend on the RIS controller. When the RIS controller is a UE, sidelink (SL) resources may be used. Alternatively, when the RIS controller is an IAB device, uplink (UL) resources, e.g., Uu resources or access link resources, may be used.

Once the UE has the allocated resource, it may use the allocated resource to send the authorization key to the RIS. If the authorization key is a digital key, the UE may first send the digital key using the allocated resource to the assigned RIS, identified by the RIS ID sent by the network along with the key. After receiving an authorization confirmation message from the RIS controller, the UE may send control signals to the RIS. The UE may send the key, and the RIS may send the confirmation messages, via messages such as SCI, UCI, DCI, MAC-CE, and/or RRC transmissions.

If the authorization key is a physical key, meaning the allocated resource itself serves as the key, the UE may send its UE ID and control signals to the RIS. The UE may send control signals to the RIS controller to control the RIS's beam angle. The control signals from the authorized UE to the RIS may be scrambled, cyphered, or encoded based on the key. In some examples, the control signals may include the UE's Global Navigation Satellite System (GNSS) position or an angle if the UE has obtained the RIS's position from the RIS. The UE may also configure reflection coefficients for the RIS. Furthermore, the UE may control the RIS to utilize one beam of the incident beam and the reflection beam pointing towards the UE itself and the other beam of the incident beam and the reflection beam pointing to a different angle, such as towards the network, another UE, or an IAB device. In some examples, the UE may also control the RIS to sweep incident and reflection beams to find the optimal beam (or the optimal pair of beams) for the RIS.

In some aspects, for network non-transparent cases, the network may possess basic information about the RIS. The network may provide RIS information to assist the UE in requesting authorization to control the RIS. The RIS information provided by the network may include the RIS ID(s) within the cell, the size(s) or coverage range(s) of the RIS, the position(s) of the RIS, the direction(s) of the RIS, and the association with a reference coordinate system. By providing this information, the network enables the UE to determine if it is within the coverage of the RIS, thereby allowing the UE to identify which RIS may serve it.

In some aspects, the network may provide the aforementioned RIS information to the UE either by broadcasting or unicasting it to a UE that has sent a dedicated request. In some examples, the network may broadcast RIS information via a SIB, either through an additional SIB for the RIS information or an additional Information Element (IE) in a SIB carrying other information. In some examples, the network may unicast the RIS information via on-demand SIB to the requesting UE. In some examples, the network may unicast the RIS information in DCI or a MAC-CE to the requesting UE. In some examples, the network may unicast the RIS occupation status (e.g., whether a RIS is occupied or non-occupied) via MAC-CE or DCI to the UE that has requested it, or broadcast/unicast this information via SIB. As used herein, the “occupied” status of a RIS means the RIS has been utilized for one or several active communications, and may not be immediately available for the requesting UE to control. On the other hand, the “non-occupied” status of a RIS means the RIS is in a passive or idle state and is available for the requesting UE to control.

In some examples, the network may assign a pair of authorization keys to the UE and the RIS, respectively, when authorizing a UE to control a RIS. For example, the network may send one key to the UE and the other key to the RIS controller. In some examples, the network may send the corresponding RIS ID to the UE.

In some examples, the network may allocate resources to the UE for the UE to send RIS control signaling. In some examples, the RIS controller may be a UE, and the allocated resources may be an SL resource. In some examples, the RIS controller may be an IAB device, and the allocated resources may be UL resources. If the authorization key is a physical key, the resource allocation itself may serve as the key. For example, the base station may indicate the resource allocation (e.g., at time and frequency domains) for the authorization to both the UE and the RIS. The UE transmits a message to the RIS using the allocated resources, and the resources on which the message are transmitted can be used by the RIS to determine that the UE has authorization to control the RIS.

In addition, the network may send the position or direction toward the network node to the RIS, enabling the RIS to configure one of the incident angle and reflection angle to be oriented towards the network entity. For example, a base station may send, to the RIS, a position or direction of the base station relative to the RIS.

In some aspects, if the authorization key is a digital key, the RIS may monitor a full set of resources for a transmission from the UE rather than a particular set of resources allocated to the UE for authorization. Upon identifying an authorization key along with its RIS ID in a transmission sent by a UE, the RIS may compare the authorization key against the previously received authorization key from the network. If the two keys are paired and conform to certain arithmetic rules, which may be configured by the network, the UE may be authorized. Subsequently, the RIS may send an authorization confirmation message to the UE. In some examples, the key may be the UE ID, and the RIS may compare the UE ID received from the UE with the UE ID received from the network to determine whether to authorize the UE (e.g., the RIS may authorize the UE if the UE IDs match).

In some aspects, the authorization key may be a physical key, and the RIS may monitor the corresponding time and frequency resource, which may be configured by the network. The RIS may determine that a UE that sends the control signal on this configured resource is authorized.

In some aspects, the RIS controller may operate according to the configurations, or control, received from the authorized UE. For example, the UE may send control information for the incident and/or reflection beam for the RIS. In such an example, RIS may set the pair of incident and reflection beams based on the control information received from the UE. In some aspects, the control information may be referred to as a configuration from the UE. The RIS may set one beam of the incident beam and the reflection beam towards the UE and the other beam of the incident beam and the reflection beam towards the network. In some examples, the RIS may sweep the incident/reflection beam pair as scheduled by the UE.

Example aspects presented herein improve the efficiency and security of UE controlling RIS. By implementing a robust authorization mechanism, the system ensures that authorized UEs are able to control the RIS and helps to avoid control by unauthorized UEs, thereby enhancing the overall network security. Additionally, by managing and coordinating the UE control of RISs through the network, the control collisions by multiple UEs to a single RIS may be reduced or avoided.

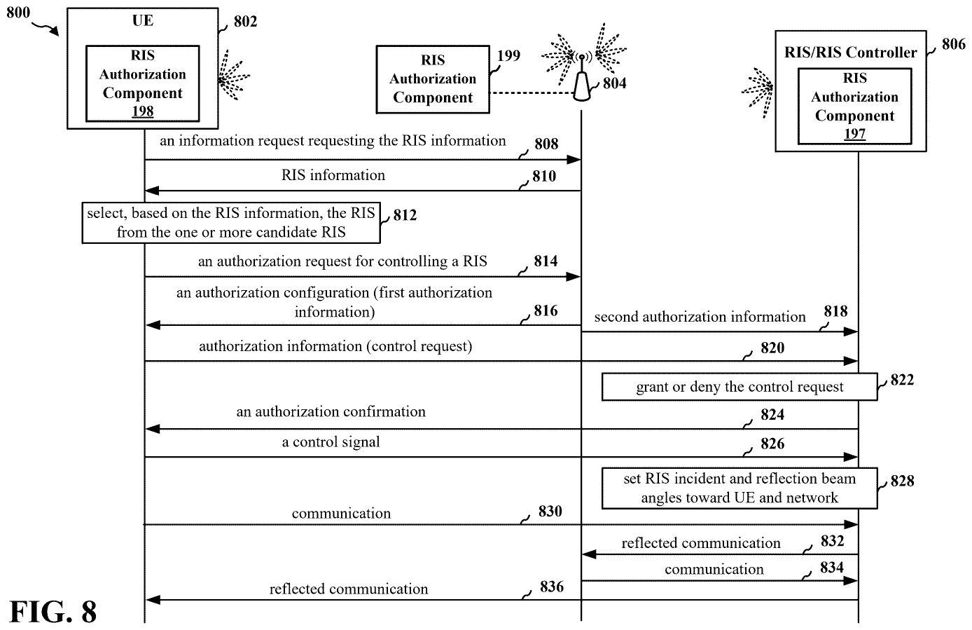

FIG. 8 is a call flow diagram 800 illustrating a method of wireless communication in accordance with various aspects of this present disclosure. Example aspects are described in connection with a base station 804, a UE 802, and a RIS (or a RIS controller) 806. Various steps in the example aspects may be respectively performed by a base station in aggregation and/or by one or more components of a base station 804 (e.g., such as a CU 110, a DU 130, and/or an RU 140), UE 802, or RIS 806.

As shown in FIG. 8, at 808, UE 802 may transmit to base station 804 an information request requesting the RIS information. UE 802 may transmit the information request via one of UCI, a MAC-CE, or RRC. For example, referring to FIG. 7, UE 704 may transmit to base station (network entity 702) an information request requesting the RIS information via one of UCI, a MAC-CE, or RRC.

At 810, base station 804 may transmit the RIS information to UE 802. In some examples, the RIS information may include one or more candidate RIS. For example, referring to FIG. 7, network entity 702 may transmit the RIS information to UE 704. The RIS information may include one or more candidate RIS, including RIS 712.

At 812, UE 802 may select, based on the received RIS information, one RIS from one or more candidate RIS. For example, referring to FIG. 7, UE 704 may select RIS 712 from one or more candidate RIS. The selection may be based on the coverage areas of the one or more candidate RIS.

At 814, UE 802 may transmit to base station 804 an authorization request for controlling the RIS. For example, referring to FIG. 7, UE 704 may transmit to network entity 702 an authorization request for controlling RIS 712.

At 816, base station 804 may transmit an authorization configuration (first authorization information) to UE 802. In some examples, the authorization configuration may include a first digital key including a data sequence. In some examples, the authorization configuration may include a physical key indicative of a transmission resource. For example, referring to FIG. 7, network entity 702 may transmit an authorization configuration (first authorization information) to UE 704. The authorization configuration may include a first digital key including a data sequence or a physical key indicative of a transmission resource.

At 818, base station 804 may transmit second authorization information to RIS 806. In some examples, the second authorization information may include a second digital key. In some examples, the second authorization information may include a transmission resource as a physical key. For example, referring to FIG. 7, network entity 702 may transmit second authorization information to RIS 712. The second authorization information may include a second digital key or a transmission resource as a physical key.

At 820, UE 802 may transmit authorization information (or a control request) to RIS 806. The authorization information may be based on the authorization configuration. For example, referring to FIG. 7, UE 704 may transmit authorization information (or a control request) to RIS 712. The authorization information may be based on the authorization configuration (e.g., the authorization information may include the first digital key).

At 822, RIS 806 may grant or deny the control request based on the authorization information it receives from UE 802. For example, referring to FIG. 7, RIS 712 may grant or deny the control request it receives from UE 704 based on the authorization information it receives.

At 824, if RIS 806 grants the control request, RIS 806 may transmit an authorization confirmation to UE 802.

At 826, upon receiving the authorization confirmation, UE 802 may send a control signal to RIS 806 to control RIS 806.

In some examples, at 828, based on the control signal, RIS 806 may set the incident and reflection beam angles toward UE 802 and base station 804. For example, referring to FIG. 7, based on the control signal, RIS 712 may set the incident and reflection beam angles toward UE 704 and network entity 702. The RIS 806 may then reflect the communication between the UE 802 and the base station 804 based on the control received from the UE 802 and/or the base station 804. For example, the communication may include communication 830 from the UE 802 that is reflected to the base station 804 at 832. The communication may include communication 834 from the base station 804 that is reflected to the UE 802 at 836.

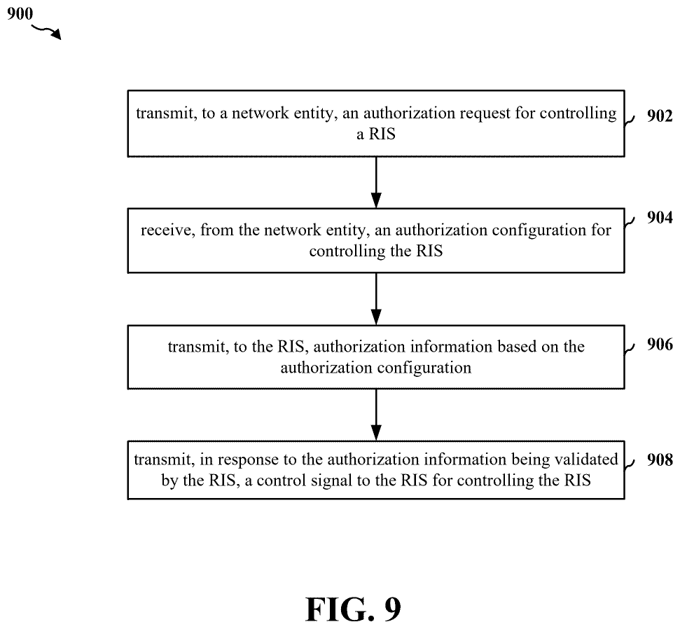

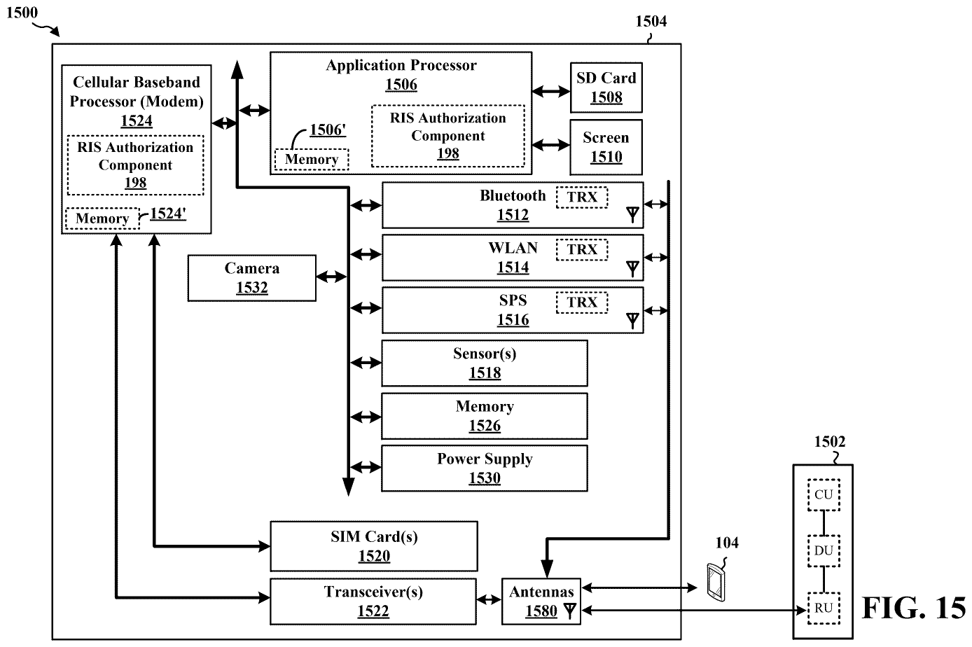

FIG. 9 is a flowchart 900 illustrating methods of wireless communication at a first UE in accordance with various aspects of the present disclosure. The method may be performed by the first UE. The first UE may be UE 104, 350, 604, 704, 802, or the apparatus 1504 in the hardware implementation of FIG. 15. The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys.

As shown in FIG. 9, at 902, the first UE may transmit, to a network entity, an authorization request for controlling a RIS. The network entity may be a base station, or a component of a base station, in the access network of FIG. 1 or a core network component (e.g., base station 102, 310, 804; network entity 602, 702; or the network entity 1502 in the hardware implementation of FIG. 15). FIGS. 6, 7, and 8 illustrate various aspects of the steps in connection with flowchart 900. For example, referring to FIG. 8, UE 802 may transmit, at 814, to a network entity (base station 804), an authorization request for controlling a RIS 806. In some aspects, 902 may be performed by the RIS authorization component 198.

At 904, the first UE may receive, from the network entity, an authorization configuration for controlling the RIS. For example, referring to FIG. 8, UE 802 may receive, at 816, from the network entity (base station 804), an authorization configuration (first authorization information) for controlling RIS 806. In some aspects, 904 may be performed by the RIS authorization component 198.

At 906, the first UE may transmit, to the RIS, authorization information based on the authorization configuration. For example, referring to FIG. 8, UE 802 may transmit, at 820, to RIS 806, authorization information based on the authorization configuration (UE 802 received at 816). In some aspects, 906 may be performed by the RIS authorization component 198.

At 908, the first UE may transmit, in response to the authorization information being validated by the RIS, a control signal to the RIS for controlling the RIS. For example, referring to FIG. 8, UE 802 may transmit, at 826, in response to the authorization information being validated by RIS 806, a control signal to RIS 806 for controlling RIS 806. In some aspects, 908 may be performed by the RIS authorization component 198.

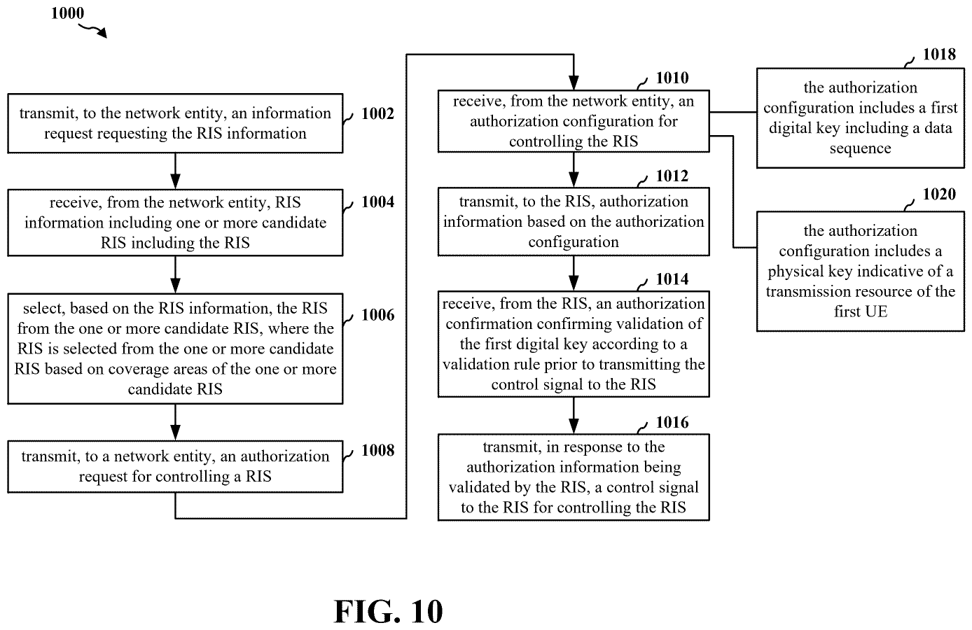

FIG. 10 is a flowchart 1000 illustrating methods of wireless communication at a first UE in accordance with various aspects of the present disclosure. The method may be performed by the first UE. The first UE may be UE 104, 350, 604, 704, 802, or the apparatus 1504 in the hardware implementation of FIG. 15. The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys.

As shown in FIG. 10, at 1008, the first UE may transmit, to a network entity, an authorization request for controlling a RIS. The network entity may be a base station, or a component of a base station, in the access network of FIG. 1 or a core network component (e.g., base station 102, 310, 804; network entity 602, 702; or the network entity 1502 in the hardware implementation of FIG. 15). FIGS. 6, 7, and 8 illustrate various aspects of the steps in connection with flowchart 1000. For example, referring to FIG. 8, UE 802 may transmit, at 814, to a network entity (base station 804), an authorization request for controlling a RIS 806. In some aspects, 1008 may be performed by the RIS authorization component 198

At 1010, the first UE may receive, from the network entity, an authorization configuration for controlling the RIS. For example, referring to FIG. 8, UE 802 may receive, at 816, from the network entity (base station 804), an authorization configuration (first authorization information) for controlling RIS 806. In some aspects, 1010 may be performed by the RIS authorization component 198.

At 1012, the first UE may transmit, to the RIS, authorization information based on the authorization configuration. For example, referring to FIG. 8, UE 802 may transmit, at 820, to RIS 806, authorization information based on the authorization configuration (UE 802 received at 816). In some aspects, 1012 may be performed by the RIS authorization component 198.

At 1016, the first UE may transmit, in response to the authorization information being validated by the RIS, a control signal to the RIS for controlling the RIS. For example, referring to FIG. 8, UE 802 may transmit, at 826, in response to the authorization information being validated by RIS 806, a control signal to RIS 806 for controlling RIS 806. In some aspects, 1016 may be performed by the RIS authorization component 198.

In some aspects, at 1018, the authorization configuration may include a first digital key including a data sequence. At 1014, the first UE may receive, from the RIS, an authorization confirmation confirming the validation of the first digital key according to a validation rule prior to transmitting the control signal to the RIS. For example, referring to FIG. 8, the authorization configuration (UE 802 received at 816) may include a first digital key including a data sequence. UE 802 may receive, at 824, from RIS 806, an authorization confirmation confirming the validation of the first digital key according to a validation rule prior to transmitting the control signal (at 826) to RIS 806. In some aspects, 1014 may be performed by the RIS authorization component 198.

In some aspects, the validation rule may include the first digital key matching a second digital key of the RIS. For example, referring to FIG. 8, the validation rule may include the first digital key (RIS 806 received at 820) matching a second digital key (RIS 806 received at 818).

In some aspects, at 1020, the authorization configuration may include a physical key indicative of a transmission resource of the first UE. The transmission resource may be used for transmitting the authorization information or the control signal to the RIS. For example, referring to FIG. 8, the authorization configuration (at 816) may include a physical key indicative of a transmission resource of UE 802. The transmission resource may be used for transmitting the authorization information (at 820) or the control signal (at 826) to RIS 806.

In some aspects, the physical key may include an RA-RNTI for the first UE. For example, referring to FIG. 8, the physical key (which may be included in the authorization configuration at 816) may include an RA-RNTI for UE 802.

In some aspects, the RIS may be a second UE of the network entity, and the transmission resource may be a sidelink transmission resource. In some aspects, the RIS may be an IAB device, and the transmission resource may be an uplink transmission resource. For example, referring to FIG. 8, in some examples, RIS 806 may be a second UE of the network entity (base station 804), and the transmission resource (which may be indicated in the authorization configuration at 816) may be a sidelink transmission resource. In some examples, RIS 806 may be an IAB device, and the transmission resource (which may be indicated in the authorization configuration at 816) may be an uplink transmission resource.

In some aspects, at 1004, the first UE may receive, from the network entity, RIS information including one or more candidate RIS including the RIS. At 1006, the first UE may select, based on the RIS information, the RIS from the one or more candidate RIS. The RIS may be selected from the one or more candidate RIS based on coverage areas of the one or more candidate RIS. For example, referring to FIG. 8, UE 802 may receive, at 810, from the network entity (base station 804), RIS information including one or more candidate RIS including the RIS. UE 802 may select, at 812, based on the RIS information, RIS 806 from the one or more candidate RIS. RIS 806 may be selected from the one or more candidate RIS based on coverage areas of the one or more candidate RIS. In some aspects, 1004 and 1006 may be performed by the RIS authorization component 198.

In some aspects, the authorization request may include one or more RIS IDs respectively corresponding to one or more selected RIS including the RIS among the one or more candidate RIS, and each of the one or more RIS IDs in the authorization request may have a selection priority. For example, referring to FIG. 8, the authorization request (at 814) may include one or more RIS IDs respectively corresponding to one or more selected RIS among the one or more candidate RIS, and each of the one or more RIS IDs in the authorization request (at 814) may have a selection priority.

In some aspects, to receive the RIS information, the first UE may be configured to: receive the RIS information via a broadcast message from the network entity. For example, referring to FIG. 8, to receive the RIS information at 810, UE 802 may receive the RIS information via a broadcast message from the network entity (base station 804).

In some aspects, at 1002, the first UE may transmit, to the network entity, an information request requesting the RIS information via one of UCI, a MAC-CE, or RRC. To receive the RIS information at 1004, the first UE may be configured to: receive the RIS information via a unicast message from the network entity. For example, referring to FIG. 8, UE 802 may transmit, at 808, to the network entity (base station 804), an information request requesting the RIS information via one of UCI, a MAC-CE, or RRC. To receive the RIS information at 810, UE 802 may receive the RIS information via a unicast message from the network entity (base station 804). In some aspects, 1002 may be performed by the RIS authorization component 198.

In some aspects, to transmit the authorization request at 1008, the first UE may be configured to: transmit the authorization request via one of UCI, a first MAC-CE, or first RRC. To receive the authorization configuration at 1010, the first UE may be configured to: receive the authorization configuration via one of: DCI, a second MAC-CE, or second RRC. The authorization configuration may further include a RIS ID corresponding to the RIS. For example, referring to FIG. 8, to transmit the authorization request at 814, UE 802 may transmit the authorization request via one of UCI, a first MAC-CE, or first RRC. To receive the authorization configuration at 816, UE 802 may receive the authorization configuration via one of: DCI, a second MAC-CE, or second RRC.

In some aspects, the control signal may be scrambled, cyphered, or encoded based on the authorization information, and the control signal may include one or more of: the GNSS position of the UE, a beam angle, one or more reflection coefficients for the RIS, an angle configuration including an incident angle and a reflection angle, or a beam sweeping configuration for the sweeping incident and reflection beams. For example, referring to FIG. 8, the control signal (at 826) may be scrambled, cyphered, or encoded based on the authorization information (at 820), and the control signal (at 826) may include one or more of: the GNSS position of UE 802, a beam angle, one or more reflection coefficients for RIS 806, an angle configuration including an incident angle and a reflection angle, or a beam sweeping configuration for the sweeping incident and reflection beams.

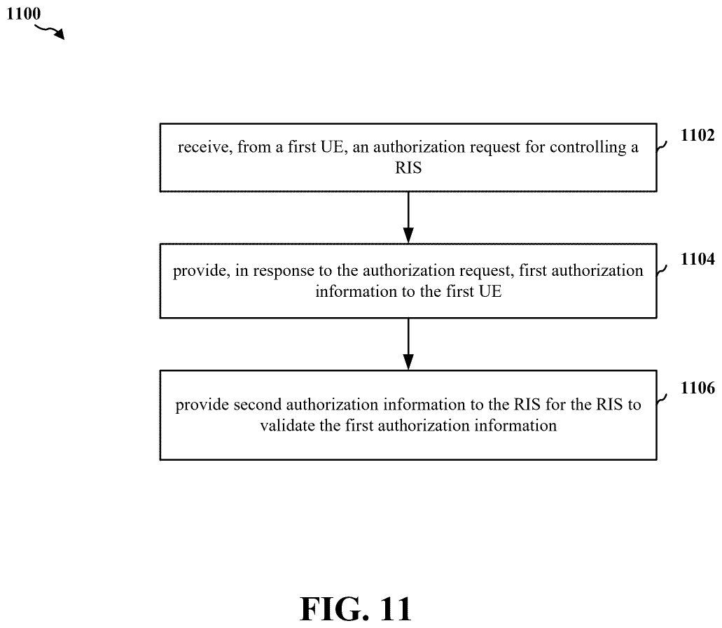

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; network entity 602, 702; or the network entity 1502 in the hardware implementation of FIG. 15). The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys. As shown in FIG. 11, at 1102, the network entity may receive, from a first UE, an authorization request for controlling a RIS. The first UE may be the UE 104, 350, 604, 704, 802, or the apparatus 1504 in the hardware implementation of FIG. 15. FIGS. 6, 7, and 8 illustrate various aspects of the steps in connection with flowchart 1100. For example, referring to FIG. 8, the network entity (base station 804) may receive, at 814, from UE 802, an authorization request for controlling RIS 806. Referring to FIG. 7, network entity 702 may receive, from UE 704, an authorization request for controlling RIS 712. In some aspects, 1102 may be performed by the RIS authorization component 199.

At 1104, the network entity may provide, in response to the authorization request, the first authorization information to the first UE. For example, referring to FIG. 8, the network entity (base station 804) may provide, at 816, in response to the authorization request (at 814), the first authorization information to UE 802. In some aspects, 1204 may be performed by the RIS authorization component 199.

At 1106, the network entity may provide second authorization information to the RIS for the RIS to validate the first authorization information. For example, referring to FIG. 8, the network entity (base station 804) may provide, at 818, second authorization information to RIS 806 for RIS 806 to validate the first authorization information (at 822). Referring to FIG. 7, network entity 702 may transmit second authorization information to RIS 712. In some aspects, 1206 may be performed by the RIS authorization component 199.

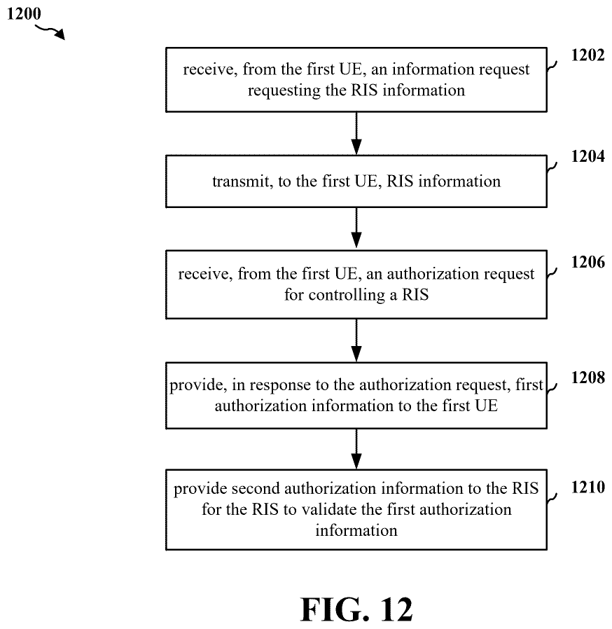

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; network entity 602, 702; or the network entity 1502 in the hardware implementation of FIG. 15). The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys.

As shown in FIG. 12, at 1206, the network entity may receive, from the first UE, an authorization request for controlling a RIS. The first UE may be the UE 104, 350, 604, 704, 802, or the apparatus 1504 in the hardware implementation of FIG. 15. FIGS. 6, 7, and 8 illustrate various aspects of the steps in connection with flowchart 1200. For example, referring to FIG. 8, the network entity (base station 804) may receive, at 814, from UE 802, an authorization request for controlling RIS 806. Referring to FIG. 7, network entity 702 may receive, from UE 704, an authorization request for controlling RIS 712. In some aspects, 1206 may be performed by the RIS authorization component 199.

At 1208, the network entity may provide, in response to the authorization request, the first authorization information to the first UE. For example, referring to FIG. 8, the network entity (base station 804) may provide, at 816, in response to the authorization request (at 814), the first authorization information to UE 802. In some aspects, 1208 may be performed by the RIS authorization component 199.

At 1210, the network entity may provide second authorization information to the RIS for the RIS to validate the first authorization information. For example, referring to FIG. 8, the network entity (base station 804) may provide, at 818, second authorization information to RIS 806 for RIS 806 to validate the first authorization information (at 822). Referring to FIG. 7, network entity 702 may transmit second authorization information to RIS 712. In some aspects, 1210 may be performed by the RIS authorization component 199.

In some aspects, at 1204, the network entity may transmit, to the first UE, RIS information. The RIS information may include one or more of: one or more RIS IDs respectively corresponding to one or more candidate RIS, coverage sizes or coverage ranges of the one or more candidate RIS, positions of the one or more candidate RIS, facing directions of the one or more RIS, or a reference coordinate system associated with the one or more candidate RIS. For example, referring to FIG. 8, the network entity (base station 804) may transmit, at 810, to UE 802, RIS information. The RIS information may include one or more of: one or more RIS IDs respectively corresponding to one or more candidate RIS, coverage sizes or coverage ranges of the one or more candidate RIS, positions of the one or more candidate RIS, facing directions of the one or more RIS, or a reference coordinate system associated with the one or more candidate RIS. In some aspects, 1204 may be performed by the RIS authorization component 199.

In some aspects, to transmit the RIS information at 1204, the network entity may be configured to: transmit the RIS information via SIB in a broadcast message. For example, referring to FIG. 8, to transmit the RIS information at 810, the network entity (base station 804) may transmit the RIS information via SIB in a broadcast message.

In some aspects, at 1202, the network entity may receive, from the first UE, an information request requesting the RIS information. In some aspects, to transmit the RIS information at 1204, the network entity may be configured to: transmit, in response to the information request, to the first UE, the RIS information in a unicast message via one of: an on-demand SIB, DCI, or a MAC-CE. For example, referring to FIG. 8, the network entity (base station 804) may receive, at 808, from UE 802, an information request requesting the RIS information. In some aspects, to transmit the RIS information at 810, the network entity (base station 804) may transmit, in response to the information request (at 808), to UE 802, the RIS information in a unicast message via one of: an on-demand SIB, DCI, or a MAC-CE. In some aspects, 1202 may be performed by the RIS authorization component 199.

In some aspects, the RIS information may include an occupation status for each of the one or more candidate RIS. For example, referring to FIG. 8, the RIS information (at 810) may include an occupation status for each of the one or more candidate RIS.

In some aspects, the first authorization information may include a first digital key, the second authorization information may include a second digital key, and the first digital key and the second digital key may conform to a validation rule. For example, referring to FIG. 8, the first authorization information (at 816) may include a first digital key, the second authorization information (at 818) may include a second digital key, and the first digital key and the second digital key may conform to a validation rule.

In some aspects, the first authorization information may further include a RIS ID associated with the RIS. For example, referring to FIG. 8, the first authorization information (at 816) may further include a RIS ID associated with RIS 806.

In some aspects, the first authorization information may include a configuration indicative of a transmission resource for the first UE. For example, referring to FIG. 8, the first authorization information (at 816) may include a configuration indicative of a transmission resource for UE 802.

In some aspects, the second authorization information may include the transmission resource as a physical key for the RIS, and the RIS may be configured to authorize the first UE in response to the transmission resource being used by the first UE to transmit a control signal. For example, referring to FIG. 8, the second authorization information (at 818) may include the transmission resource as a physical key for RIS 806. RIS 806 may authorize UE 802 in response to the transmission resource (which may be indicated in the second authorization information) being used by UE 802 to transmit a control signal (at 826).

In some aspects, the RIS may be a second UE of the network entity, and the transmission resource may be a sidelink transmission resource. Alternatively, the RIS may be an IAB device, and the transmission resource may be an uplink transmission resource. For example, referring to FIG. 8, RIS 806 may be a second UE of the network entity (base station 804), and the transmission resource (which may be indicated in the first authorization information) may be a sidelink transmission resource. Alternatively, RIS 806 may be an IAB device, and the transmission resource (which may be indicated in the first authorization information) may be an uplink transmission resource.

In some aspects, the second authorization information may include: a position or orientation of the network entity. For example, referring to FIG. 8, the second authorization information (at 818) may include a position or orientation of the network entity (base station 804).

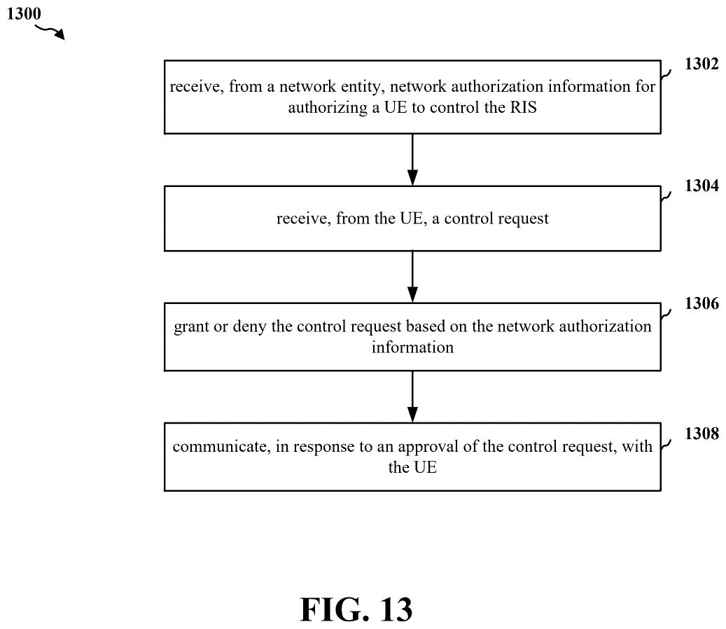

FIG. 13 is a flowchart 1300 illustrating methods of wireless communication at a RIS in accordance with various aspects of the present disclosure. The method may be performed by a RIS. The RIS may be RIS 103, 506, 612, 712, or 806. The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys.

As shown in FIG. 13, at 1302, the RIS may receive, from a network entity, network authorization information for authorizing a UE to control the RIS. The network entity may be a base station, or a component of a base station, in the access network of FIG. 1 or a core network component (e.g., base station 102, 310, 804; network entity 602, 702; or the network entity 1502 in the hardware implementation of FIG. 15). The UE may be UE 104, 350, 604, 704, 802, or the apparatus 1504 in the hardware implementation of FIG. 15. FIGS. 6, 7, and 8 illustrate various aspects of the steps in connection with flowchart 1300. For example, referring to FIG. 8, RIS 806 may receive, at 818, from a network entity (base station 804), network authorization information (second authorization information) for authorizing UE 802 to control RIS 806. In some aspects, 1302 may be performed by the RIS authorization component 197.

At 1304, the RIS may receive a control request from the UE. For example, referring to FIG. 8, RIS 806 may receive, at 820, a control request from UE 802. In some aspects, 1304 may be performed by the RIS authorization component 197.

At 1306, the RIS may grant or deny the control request based on the network authorization information. For example, referring to FIG. 8, RIS 806 may, at 822, grant or deny the control request based on the network authorization information (second authorization information at 818). In some aspects, 1306 may be performed by the RIS authorization component 197.

At 1308, the RIS may communicate, in response to an approval of the control request, with the UE. For example, referring to FIG. 7, RIS 712 may communicate, in response to an approval of the control request, with UE 704. In some aspects, 1308 may be performed by the RIS authorization component 197.

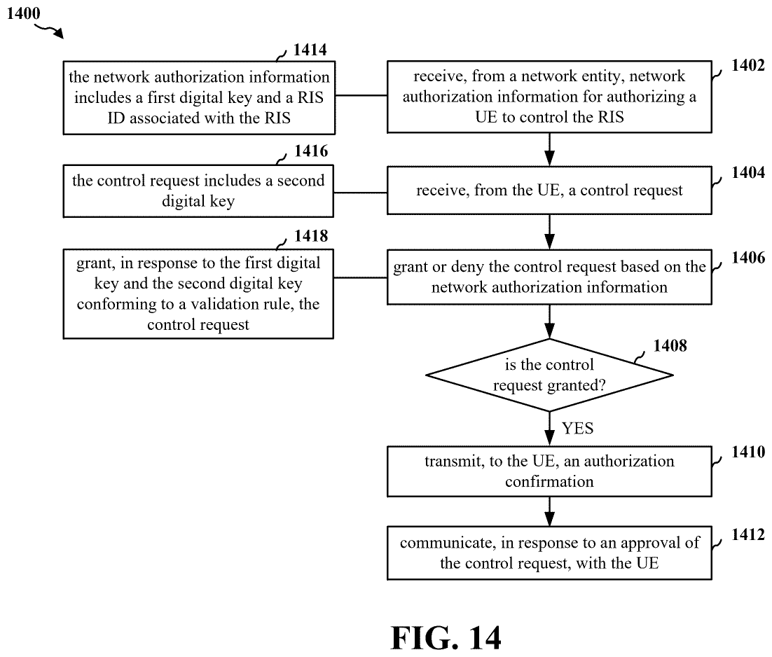

FIG. 14 is a flowchart 1400 illustrating methods of wireless communication at a RIS in accordance with various aspects of the present disclosure. The method may be performed by a RIS. The RIS may be RIS 103, 506, 612, 712, or 806. The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys.

As shown in FIG. 14, at 1402, the RIS may receive, from a network entity, network authorization information for authorizing a UE to control the RIS. The network entity may be a base station, or a component of a base station, in the access network of FIG. 1 or a core network component (e.g., base station 102, 310, 804; network entity 602, 702; or the network entity 1502 in the hardware implementation of FIG. 15). The UE may be UE 104, 350, 604, 704, 802, or the apparatus 1504 in the hardware implementation of FIG. 15. FIGS. 6, 7, and 8 illustrate various aspects of the steps in connection with flowchart 1400. For example, referring to FIG. 8, RIS 806 may receive, at 818, from a network entity (base station 804), network authorization information (second authorization information) for authorizing UE 802 to control RIS 806. In some aspects, 1402 may be performed by the RIS authorization component 197.

At 1404, the RIS may receive a control request from the UE. For example, referring to FIG. 8, RIS 806 may receive, at 820, a control request from UE 802. In some aspects, 1404 may be performed by the RIS authorization component 197.

At 1406, the RIS may grant or deny the control request based on the network authorization information. For example, referring to FIG. 8, RIS 806 may, at 822, grant or deny the control request based on the network authorization information (second authorization information at 818). In some aspects, 1406 may be performed by the RIS authorization component 197.

If the control request is approved at 1408, the RIS may communicate, at 1412, with the UE. For example, referring to FIG. 8, if the control request is approved at 822, RIS 806 may communicate with UE 802. In some aspects, 1408 and 1412 may be performed by the RIS authorization component 197.

In some aspects, at 1414, the network authorization information may include a first digital key and a RIS ID associated with the RIS, and, at 1416, the control request may include a second digital key. To grant or deny the control request at 1406, the RIS may be configured to: at 1418, grant, in response to the first digital key and the second digital key conforming to a validation rule, the control request. For example, referring to FIG. 8, the network authorization information (second authorization information at 818) may include a first digital key and a RIS ID associated with RIS 806. The control request (at 820) may include a second digital key. RIS 806 may grant, at 822, in response to the first digital key and the second digital key conforming to a validation rule, the control request (received at 820).

In some aspects, the validation rule may be the first digital key matches the second digital key. For example, referring to FIG. 8, the validation rule may be the first digital key (received at 820) matches the second digital key (received at 818).

In some aspects, at 1410, the RIS may transmit, to the UE, in response to granting the control request, an authorization confirmation. For example, referring to FIG. 8, RIS 806 may transmit, at 824, to UE 802, in response to granting the control request (at 822), an authorization confirmation. In some aspects, 1410 may be performed by the RIS authorization component 197.

In some aspects, the network authorization information may include a configuration indicative of a first transmission resource of the UE, and, to grant or deny the control request at 1406, the RIS may be configured to: monitor the first transmission resource; and grant, in response to the control request being received via the first transmission resource, the control request. For example, referring to FIG. 8, the network authorization information (second authorization information at 818) may include a configuration indicative of a first transmission resource of UE 802. RIS 806 may monitor the first transmission resource, and grant, at 822, in response to the control request being received (at 820) via the first transmission resource, the control request. In some aspects, to communicate with the UE at 1412, the RIS may be configured to: receive a control signal from the UE, where the control signal includes a beam pattern for the RIS, and communicate with the UE based on the beam pattern. The beam pattern may include one or more of: a first incident beam for the UE, a first reflection beam for the network entity, or one or more beam pairs for beam sweeping. Each of the one or more beam pairs may include a second incident beam for the UE and a second reflection beam for the network entity. For example, referring to FIG. 8, RIS 806 may set RIS incident and reflection beam angles toward UE 802 and base station 804.

In some aspects, the control signal may be scrambled, cyphered, or encoded based on the network authorization information. For example, referring to FIG. 8, the control signal (at 826) may be scrambled, cyphered, or encoded based on the network authorization information (second authorization information at 818).

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see UE 350 of FIG. 3) and include the additional modules of the apparatus 1504.

As discussed supra, the RIS authorization component 198 may be configured to transmit, to a network entity, an authorization request for controlling a RIS; receive, from the network entity, an authorization configuration for controlling the RIS; transmit, to the RIS, authorization information based on the authorization configuration; and transmit, in response to the authorization information being validated by the RIS, a control signal to the RIS for controlling the RIS. The RIS authorization component 198 may be further configured to perform any of the aspects described in connection with the flowcharts in FIG. 9 and FIG. 10, and/or performed by the UE 802 in FIG. 8 and/or the UE 404b, 504, 604, or 704 in FIG. 4A-7. The RIS authorization component 198 may be within the cellular baseband processor 1524, the application processor 1506, or both the cellular baseband processor 1524 and the application processor 1506. The RIS authorization component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, includes means for transmitting, to a network entity, an authorization request for controlling a RIS, means for receiving, from the network entity, an authorization configuration for controlling the RIS, means for transmitting, to the RIS, authorization information based on the authorization configuration, and means for transmitting, in response to the authorization information being validated by the RIS, a control signal to the RIS for controlling the RIS. The apparatus 1504 may further include means for performing any of the aspects described in connection with the flowcharts in FIG. 9 and FIG. 10, and/or aspects performed by the UE 802 in FIG. 8 and/or the UE 404b, 504, 604, or 704 in FIG. 4A-7. The means may be the RIS authorization component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

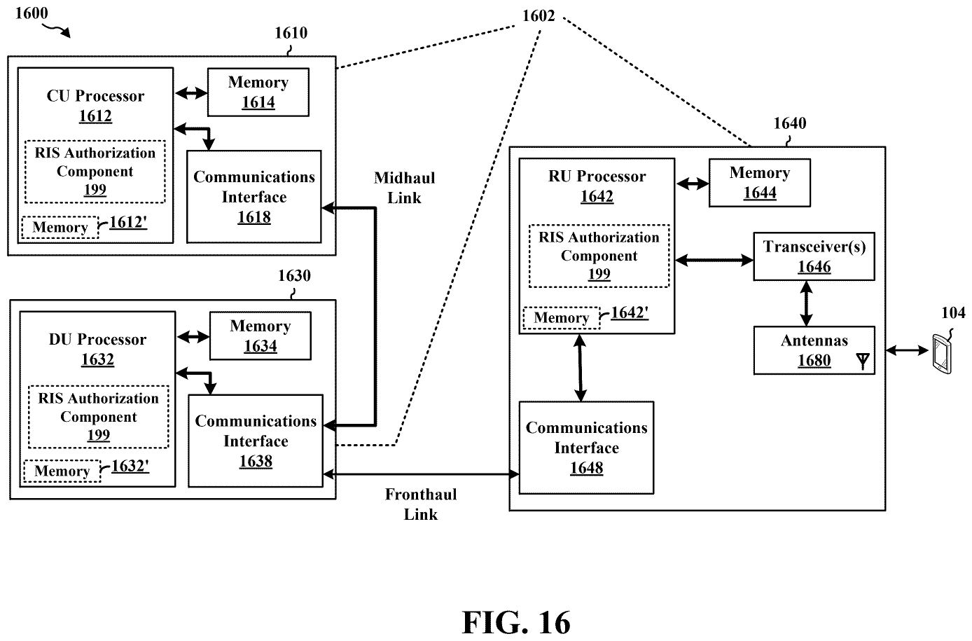

FIG. 16 is a diagram 1600 illustrating an example of a hardware implementation for a network entity 1602, which may also be referred to as a network node. The network entity 1602 may be a base station, a component of a base station, or may implement base station functionality. The network entity 1602 may include at least one of a CU 1610, a DU 1630, or an RU 1640. For example, depending on the layer functionality handled by the RIS authorization component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RIS authorization component 199 may be configured to receive, from a first UE, an authorization request for controlling a RIS; provide, in response to the authorization request, the first authorization information to the first UE; and provide second authorization information to the RIS for the RIS to validate the first authorization information. The RIS authorization component 199 may be further configured to perform any of the aspects described in connection with the flowcharts in FIG. 11 and FIG. 12, and/or performed by the base station 804 in FIG. 8, the base station 402, 502 in FIG. 4A-5, and/or the network entity 602 or 702 in FIG. 6 or 7. The RIS authorization component 199 may be within one or more processors of one or more of the CU 1610, DU 1630, and the RU 1640. The RIS authorization component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for receiving, from a first UE, an authorization request for controlling a RIS, means for providing, in response to the authorization request, the first authorization information to the first UE, and means for providing second authorization information to the RIS for the RIS to validate the first authorization information. The network entity 1602 may further include means for performing any of the aspects described in connection with the flowcharts in FIG. 11 and FIG. 12, and/or aspects performed by the base station 804 in FIG. 8, the base station 402, 502 in FIG. 4A-5, and/or the network entity 602 or 702 in FIG. 6 or 7. The means may be the RIS authorization component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

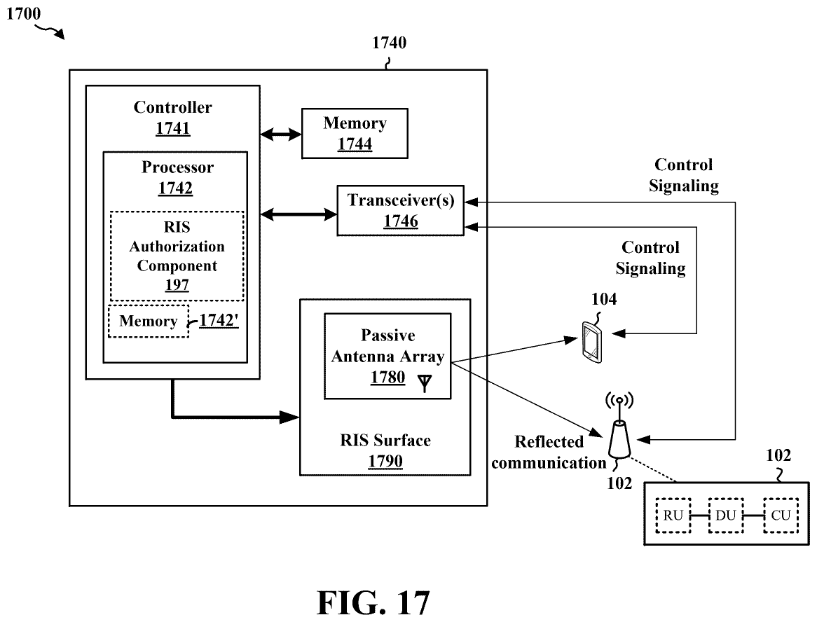

FIG. 17 is a diagram 1700 illustrating an example of a hardware implementation for a RIS 1740. The RIS 1740 includes a RIS surface 1790 that includes a passive antenna array 1780. The RIS surface 1790 includes a surface with a large number of densely placed reconfigurable elements that can reflect or refract an electromagnetic wave in target directions. FIG. 17 illustrates an example of the RIS surface 1790 reflecting communication between a UE 104 and a base station 102. The RIS 1740 includes a controller 1741 that controls an incident angle and an angle of reflection, e.g., by controlling reflection coefficients of the antenna elements of the RIS surface 1790. Although FIG. 17 illustrates the controller 1741 comprised in the RIS 1740, in some aspects, the controller 1741 may be another device, such as a UE, IAB node, etc., such as illustrated in the example in FIGS. 6 and 7. The controller 1741 may exchange communication, including control signaling or other signaling with a network node such as a base station 102 or a component of a base station 102 and/or a UE 104. The controller 1741 may exchange the communication via at least one transceiver 1746. The controller 1741 may include a processor 1742. The processor 1742 may include on-chip memory 1742′. In some aspects, the controller 1741 may further include additional memory modules 1744. The on-chip memory 1742′ and the additional memory modules 1744 may each be considered a computer-readable medium/memory. Each computer-readable medium/memory may be non-transitory. The processor 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RIS authorization component 197 may be configured to receive, from a network entity, network authorization information for authorizing a UE to control the RIS; receive, from the UE, a control request; grant or deny the control request based on the network authorization information; and communicate, in response to an approval of the control request, with the UE. The RIS authorization component, and/or another component of the RIS may be configured to perform any of the aspects performed by the RIS in the flowchart of FIG. 13 or 14, the communication flow of FIG. 8, and/or the diagrams in FIGS. 4A-7. The RIS authorization component 197 may be within the processor 1742. The RIS authorization component 197 may be one or more hardware components specifically configured to carry out the stated processes/algorithm, implemented by one or more processors configured to perform the stated processes/algorithm, stored within a computer-readable medium for implementation by one or more processors, or some combination thereof. The RIS 1740 may include a variety of components configured for various functions. In one configuration, the RIS 1740 may include means for receiving, from a network entity, network authorization information for authorizing a UE to control the RIS, means for receiving, from the UE, a control request, means for granting or denying the control request based on the network authorization information, and means for communicating, in response to an approval of the control request, with the UE. The RIS 1740 may further includes means for performing any of the aspects performed by the RIS in the flowchart of FIG. 13 or 14, the communication flow of FIG. 8, and/or the diagrams in FIGS. 4A-7. The means may be the RIS authorization component 197 of the RIS 1740 configured to perform the functions recited by the means.

This disclosure provides a method for wireless communication at a UE. The method may include transmitting, to a network entity, an authorization request for controlling a RIS; receiving, from the network entity, an authorization configuration for controlling the RIS; transmitting, to the RIS, authorization information based on the authorization configuration; and transmitting, in response to the authorization information being validated by the RIS, a control signal to the RIS for controlling the RIS. The method improves the efficiency and security of UE controlling RIS, while avoiding control collisions when multiple UEs attempt to control the same RIS. This is achieved by implementing a robust authorization process involving base station, UE, and RIS controller, using either paired digital keys or physical keys as authorization keys.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE. The method may include transmitting, to a network entity, an authorization request for controlling a RIS; receiving, from the network entity, an authorization configuration for controlling the RIS; transmitting, to the RIS, authorization information based on the authorization configuration; and transmitting, in response to the authorization information being validated by the RIS, a control signal to the RIS for controlling the RIS.

Aspect 2 is the method of aspect 1, where the authorization configuration may include a first digital key including a data sequence, and the method may further include: receiving, from the RIS, an authorization confirmation confirming validation of the first digital key according to a validation rule prior to transmitting the control signal to the RIS.

Aspect 3 is the method of aspect 2, where the validation rule may include the first digital key matching a second digital key of the RIS.

Aspect 4 is the method of aspect 1, where the authorization configuration may include a physical key indicative of a transmission resource of the first UE, and the transmission resource may be used for transmitting the authorization information or the control signal to the RIS.

Aspect 5 is the method of aspect 4, where the physical key may include an RA-RNTI for the first UE.

Aspect 6 is the method of aspect 4, where the RIS may be a second UE of the network entity, and the transmission resource may be a sidelink transmission resource. Alternatively, the RIS may be an IAB device, and the transmission resource may be an uplink transmission resource.

Aspect 7 is the method of any of aspects 1 to 6, where the method may further include, prior to transmitting the authorization request for controlling the RIS to the network entity: receiving, from the network entity, RIS information including one or more candidate RIS including the RIS; and selecting, based on the RIS information, the RIS from the one or more candidate RIS. The RIS may be selected from the one or more candidate RIS based on coverage areas of the one or more candidate RIS.

Aspect 8 is the method of aspect 7, where the authorization request may include one or more RIS IDs respectively corresponding to one or more selected RIS including the RIS among the one or more candidate RIS, and each of the one or more RIS IDs in the authorization request may have a selection priority.

Aspect 9 is the method of aspect 7, where receiving the RIS information may include: receiving the RIS information via a broadcast message from the network entity.

Aspect 10 is the method of aspect 7, where the method may further include, prior to receiving the RIS information: transmitting, to the network entity, an information request requesting the RIS information via one of UCI, a MAC-CE, or RRC, and receiving the RIS information may include: receiving the RIS information via a unicast message from the network entity.

Aspect 11 is the method of aspect 7, where transmitting the authorization request may include: transmitting the authorization request via one of UCI, a first MAC-CE, or first RRC, and receiving the authorization configuration may include: receiving the authorization configuration via one of: DCI, a second MAC-CE, or second RRC, and

the authorization configuration may further include a RIS ID corresponding to the RIS.

Aspect 12 is the method of any of aspects 1 to 11, where the control signal may be scrambled, cyphered, or encoded based on the authorization information, and the control signal may include one or more of: the GNSS position of the UE, a beam angle, one or more reflection coefficients for the RIS, an angle configuration including an incident angle and a reflection angle, or a beam sweeping configuration for the sweeping incident and reflection beams.

Aspect 13 is an apparatus for wireless communication at a UE, including: at least one memory; and at least one processor coupled to the at least one memory and, based at least in part on information stored in the at least one memory, the at least one processor is configured to perform the method of any of aspects 1-12.

Aspect 14 is the apparatus of aspect 13, further including at least one of a transceiver or an antenna coupled to the at least one processor and configured to transmit the authorization request.

Aspect 15 is an apparatus for wireless communication including means for implementing the method of any of aspects 1-12.

Aspect 16 is a computer-readable medium (e.g., a non-transitory computer-readable medium) storing computer-executable code, where the code when executed by a processor causes the processor to implement the method of any of aspects 1-12.

Aspect 17 is a method of wireless communication at a network entity. The method may include receiving, from a first UE, an authorization request for controlling a RIS; providing, in response to the authorization request, the first authorization information to the first UE; and providing second authorization information to the RIS for the RIS to validate the first authorization information.

Aspect 18 is the method of aspect 17, where the method may further include, prior to receiving the authorization request: transmitting, to the first UE, RIS information. The RIS information may include one or more of: one or more RIS IDs respectively corresponding to one or more candidate RIS, coverage sizes or coverage ranges of the one or more candidate RIS, positions of the one or more candidate RIS, facing directions of the one or more RIS, or a reference coordinate system associated with the one or more candidate RIS.

Aspect 19 is the method of aspect 18, where transmitting the RIS information may include: transmitting the RIS information via SIB in a broadcast message.

Aspect 20 is the method of aspect 18, where the method may further include receiving, from the first UE, an information request requesting the RIS information, and transmitting the RIS information may include: transmitting, in response to the information request, to the first UE, the RIS information in a unicast message via one of: an on-demand SIB, DCI, or a MAC-CE.

Aspect 21 is the method of aspect 18, where the RIS information may include an occupation status for each of the one or more candidate RIS.

Aspect 22 is the method of aspect 17, where the first authorization information may include a first digital key, the second authorization information may include a second digital key, and the first digital key and the second digital key may conform to a validation rule.

Aspect 23 is the method of aspect 22, where the first authorization information may further include a RIS ID associated with the RIS.

Aspect 24 is the method of aspect 17, where the first authorization information may include a configuration indicative of a transmission resource for the first UE.

Aspect 25 is the method of aspect 24, where the second authorization information may include the transmission resource as a physical key for the RIS, and the RIS may be configured to authorize the first UE in response to the transmission resource being used by the first UE to transmit a control signal.

Aspect 26 is the method of aspect 24, where the RIS may be a second UE of the network entity, and the transmission resource may be a sidelink transmission resource. Alternatively, the RIS may be an IAB device, and the transmission resource may be an uplink transmission resource.

Aspect 27 is the method of any of aspects 17 to 26, where the second authorization information may include a position or orientation of the network entity.

Aspect 28 is an apparatus for wireless communication at a network entity, including: at least one memory; and at least one processor coupled to the at least one memory and, based at least in part on information stored in the at least one memory, the at least one processor is configured to perform the method of any of aspects 17-27.

Aspect 29 is the apparatus of aspect 28, further including at least one of a transceiver or an antenna coupled to the at least one processor and configured to receive the authorization request.

Aspect 30 is an apparatus for wireless communication including means for implementing the method of any of aspects 17-27.

Aspect 31 is a computer-readable medium (e.g., a non-transitory computer-readable medium) storing computer-executable code, where the code when executed by a processor causes the processor to implement the method of any of aspects 17-27.

Aspect 32 is a method of wireless communication at a RIS. The method may include receiving, from a network entity, network authorization information for authorizing a UE to control the RIS; receiving, from the UE, a control request; granting or denying the control request based on the network authorization information; and communicating, in response to an approval of the control request, with the UE.

Aspect 33 is the method of aspect 32, where the network authorization information may include a first digital key and a RIS ID associated with the RIS, the control request may include a second digital key, and granting or denying the control request may include: granting, in response to the first digital key and the second digital key conforming to a validation rule, the control request.

Aspect 34 is the method of aspect 33, where the validation rule may be the first digital key matches the second digital key.

Aspect 35 is the method of any of aspects 32 to 34, where the method may further include transmitting, to the UE, in response to granting the control request, an authorization confirmation.

Aspect 36 is the method of aspect 32, where the network authorization information may include a configuration indicative of a first transmission resource of the UE, and granting or denying the control request may include: monitoring the first transmission resource; and granting, in response to the control request being received via the first transmission resource, the control request.

Aspect 37 is the method of aspect 32, where communicating with the UE may include: receiving a control signal from the UE, where the control signal may include a beam pattern for the RIS, and communicating with the UE based on the beam pattern. The beam pattern may include one or more of: a first incident beam for the UE, a first reflection beam for the network entity, or one or more beam pairs for beam sweeping. Each of the one or more beam pairs may include a second incident beam for the UE and a second reflection beam for the network entity.

Aspect 38 is the method of aspect 37, where the control signal may be scrambled, cyphered, or encoded based on the network authorization information.

Aspect 39 is an apparatus for wireless communication at a RIS, including: at least one memory; and at least one processor coupled to the at least one memory and, based at least in part on information stored in the at least one memory, the at least one processor is configured to perform the method of any of aspects 32-38.

Aspect 40 is the apparatus of aspect 39, further including at least one of a transceiver or an antenna coupled to the at least one processor and configured to receive the network authorization information.

Aspect 41 is an apparatus for wireless communication including means for implementing the method of any of aspects 32-38.

Aspect 42 is a computer-readable medium (e.g., a non-transitory computer-readable medium) storing computer-executable code, where the code when executed by a processor causes the processor to implement the method of any of aspects 32-38.

1. An apparatus for wireless communication at a first user equipment (UE), comprising:
at least one memory; and
at least one processor coupled to the at least one memory and, based at least in part on information stored in the at least one memory, the at least one processor is configured to:
transmit, to a network entity, an authorization request for controlling a reconfigurable intelligent surface (RIS);
receive, from the network entity, an authorization configuration for controlling the RIS;
transmit, to the RIS, authorization information based on the authorization configuration; and
transmit, in response to the authorization information being validated by the RIS, a control signal to the RIS for controlling the RIS.

2. The apparatus of claim 1, further comprising a transceiver coupled to the at least one processor, wherein, to transmit the authorization request for controlling the RIS, the at least one processor is configured to transmit the authorization request for controlling the RIS via the transceiver, and wherein the authorization configuration includes a first digital key comprising a data sequence, and wherein the at least one processor is further configured to:
receive, from the RIS, an authorization confirmation confirming validation of the first digital key according to a validation rule prior to transmitting the control signal to the RIS.

3. The apparatus of claim 2, wherein the validation rule includes the first digital key matching a second digital key of the RIS.

4. The apparatus of claim 1, wherein the authorization configuration includes a physical key indicative of a transmission resource of the first UE, wherein the transmission resource is used for transmitting the authorization information or the control signal to the RIS.

5. (canceled)

6. (canceled)

7. The apparatus of claim 1, wherein the at least one processor is further configured to, prior to being configured to transmit the authorization request for controlling the RIS to the network entity:
receive, from the network entity, RIS information comprising one or more candidate RIS including the RIS; and
select, based on the RIS information, the RIS from the one or more candidate RIS, wherein the RIS is selected from the one or more candidate RIS based on coverage areas of the one or more candidate RIS.

8. (canceled)

9. (canceled)

10. The apparatus of claim 7, wherein the at least one processor is further configured to, prior to being configured to receive the RIS information:
transmit, to the network entity, an information request requesting the RIS information via one of uplink control information (UCI), a medium access control-control element (MAC-CE), or radio resource control (RRC), and wherein, to receive the RIS information, the at least one processor is configured to:
receive the RIS information via a unicast message from the network entity.

11. The apparatus of claim 7, wherein, to transmit the authorization request, the at least one processor is configured to:
transmit the authorization request via one of uplink control information (UCI), a first medium access control-control element (MAC-CE), or first radio resource control (RRC), wherein, to receive the authorization configuration, the at least one processor is configured to:
receive the authorization configuration via one of: downlink control information (DCI), a second MAC-CE, or second RRC, wherein the authorization configuration further comprises a RIS ID corresponding to the RIS.

12. The apparatus of claim 1, wherein the control signal is scrambled, cyphered, or encoded based on the authorization information, and wherein the control signal includes one or more of:
global navigation satellite system (GNSS) position of the UE,
a beam angle,
one or more reflection coefficients for the RIS,
an angle configuration including an incident angle and a reflection angle, or
a beam sweeping configuration for sweeping incident and reflection beams.

13. An apparatus of wireless communication at a network entity, comprising:
at least one memory; and
at least one processor coupled to the at least one memory and, based at least in part on information stored in the at least one memory, the at least one processor is configured to:
receive, from a first user equipment (UE), an authorization request for controlling a reconfigurable intelligent surface (RIS);
provide, in response to the authorization request, first authorization information to the first UE; and
provide second authorization information to the RIS for the RIS to validate the first authorization information.

14. The apparatus of claim 13, further comprising a transceiver coupled to the at least one processor, wherein, to receive the authorization request for controlling the RIS, the at least one processor is configured to receive the authorization request for controlling the RIS via the transceiver, and wherein the at least one processor is further configured to, prior to being configured to receive the authorization request:
transmit, to the first UE, RIS information, wherein the RIS information comprises one or more of:
one or more RIS identifiers (IDs) respectively corresponding to one or more candidate RIS,
coverage sizes or coverage ranges of the one or more candidate RIS,
positions of the one or more candidate RIS,
facing directions of the one or more RIS, or
a reference coordinate system associated with the one or more candidate RIS.

15. The apparatus of claim 14, wherein, to transmit the RIS information, the at least one processor is configured to:
transmit the RIS information via System Information Block (SIB) in a broadcast message.

16. The apparatus of claim 14, wherein the at least one processor is further configured to:
receive, from the first UE, an information request requesting the RIS information, and wherein, to transmit the RIS information, the at least one processor is configured to:
transmit, in response to the information request, to the first UE, the RIS information in a unicast message via one of:
an on-demand System Information Block (SIB),
downlink control information (DCI), or
a medium access control-control element (MAC-CE).

17. (canceled)

18. The apparatus of claim 13, wherein the first authorization information includes a first digital key, the second authorization information includes a second digital key, wherein the first digital key and the second digital key conform to a validation rule.

19. (canceled)

20. The apparatus of claim 13, wherein the first authorization information includes a configuration indicative of a transmission resource for the first UE.

21. The apparatus of claim 20, wherein the second authorization information includes the transmission resource as a physical key for the RIS, wherein the RIS is configured to authorize the first UE in response to the transmission resource being used by the first UE to transmit a control signal.

22. (canceled)

23. The apparatus of claim 13, wherein the second authorization information comprises:
a position or orientation of the network entity.

24. An apparatus of wireless communication at a reconfigurable intelligent surface (RIS), comprising:
at least one memory; and
at least one processor coupled to the at least one memory and, based at least in part on information stored in the at least one memory, the at least one processor is configured to:
receive, from a network entity, network authorization information for authorizing a user equipment (UE) to control the RIS;
receive, from the UE, a control request;
grant or deny the control request based on the network authorization information; and
communicate, in response to an approval of the control request, with the UE.

25. The apparatus of claim 24, further comprising a transceiver coupled to the at least one processor, wherein, to receive the network authorization information, the at least one processor is configured to receive the network authorization information via the transceiver, wherein the network authorization information includes a first digital key and a RIS identifier (ID) associated with the RIS, and wherein the control request comprises a second digital key, and wherein, to grant or deny the control request, the at least one processor is configured to:
grant, in response to the first digital key and the second digital key conforming to a validation rule, the control request.

26. (canceled)

27. (canceled)

28. The apparatus of claim 24, wherein the network authorization information includes a configuration indicative of a first transmission resource of the UE, and wherein, to grant or deny the control request, the at least one processor is configured to:
monitor the first transmission resource; and
grant, in response to the control request being received via the first transmission resource, the control request.

29. The apparatus of claim 24, wherein, to communicate with the UE, the at least one processor is configured to:
receive a control signal from the UE, wherein the control signal comprises a beam pattern for the RIS, and
communicate with the UE based on the beam pattern, wherein the beam pattern includes one or more of:
a first incident beam for the UE,
a first reflection beam for the network entity, or
one or more beam pairs for beam sweeping, wherein each of the one or more beam pairs includes a second incident beam for the UE and a second reflection beam for the network entity.

30. (canceled)
